(19) United States
(12) Patent Application Publication
(10) Pub. No.: US 2014/0344024 A1
(43) Pub. Date: Nov. 20, 2014

(54) BUSINESS COCKPITS BASED ON IN-MEMORY DATABASE

(71) Applicants: Dirk Kempf, Walldorf (DE); Daniel Huber, Walzbachtal (DE); Martin Ebert, Karlsruhe (DE); Marcus Behrens, Heidelberg (DE); Christoph Boehm, Bensheim (DE); Marcel Waechter, Graben-Neudorf (DE); Holger Bohle, Dielheim (DE); Harish Rama Rao, Bangalore (IN); Anirban Kundu, Bangalore (IN); Thomas Fleckenstein, Frankenthal (DE)

(72) Inventors: Dirk Kempf, Walldorf (DE); Daniel Huber, Walzbachtal (DE); Martin Ebert, Karlsruhe (DE); Marcus Behrens, Heidelberg (DE); Christoph Boehm, Bensheim (DE); Marcel Waechter, Graben-Neudorf (DE); Holger Bohle, Dielheim (DE); Harish Rama Rao, Bangalore (IN); Anirban Kundu, Bangalore (IN); Thomas Fleckenstein, Frankenthal (DE)

(73) Assignee: SAP AG, Walldorf (DE)

(21) Appl. No.: 13/955,882

(22) Filed: Jul. 31, 2013

(30) Foreign Application Priority Data
May 14, 2013 (IN) 1423/DEL/2013

(51) Int. Cl. G06Q 10/06; G06F 17/22; G06F 3/0482

(52) U.S. Cl. CPC G06Q 10/06393; G06F 3/0482; G06F 17/2247
USPC 705/7.39

(57) ABSTRACT

Embodiments of the present disclosure provide systems and methods for a lightweight monitoring application with key performance indicators (KPI) reporting and management. The method may include displaying a page with a plurality of tiles on a user device. The tiles displayed on the page may include a plurality of key performance indicator (KPI) tiles and at least one of a report tile, a news tile and a collaboration tile. The method may retrieve metadata from an in-memory database, the metadata from the in-memory database may correspond to content displayed in at least one of the KPI tiles on the page. In response to an input from a user input apparatus selecting one of the tiles displayed on the page, the method may display additional details or controls for the selected tile.

### CROSS-REFERENCE TO RELATED APPLICATION

This application claims priority of Indian Patent Application No. 1423/DEL/2013 filed May 14, 2013, the contents of which is incorporated herein by reference.

### BACKGROUND

In today's competitive markets, managers of organizations need to make quick decisions based on constantly changing conditions. Managers need simple and attractive ways to analyze a situation, share the findings and make quick decisions. Existing services are complicated and do not always provide real time evaluation of the always changing conditions.

In addition, organizations today need to make decisions based on many factors that may include analyzing vast amounts of data. Existing methods do not provide solutions to analyze large amounts of data quickly and to provide real time results of such analysis. Thus, managers are limited in how fast they can make decisions and on what data they make such decisions.

### BRIEF DESCRIPTION OF THE DRAWINGS

The accompanying drawings illustrate the various embodiments and, together with the description, further serve to explain the principles of the embodiments and to enable one skilled in the pertinent art to make and use the embodiments.

FIG. 1 illustrates an exemplary integrated platform that includes a plurality of universal pages according to an embodiment of the present disclosure.

FIG. 2 illustrates possible paths for the first level navigation of the tiles shown in FIG. 1.

FIG. 3 illustrates basic building blocks of the KPI cockpit architecture according to an embodiment of the present disclosure.

FIG. 4 illustrates system integrating of a web application server and an in-memory database to provide a KPI cockpit according to an embodiment of the present disclosure.

FIG. 5 is a block diagram of an exemplary computer system that may be used with the embodiments of the present disclosure.

### DETAILED DESCRIPTION

Embodiments of the present disclosure provide systems and methods for a lightweight monitoring application with key performance indicators (KPI) reporting and management. The method may include displaying a page with a plurality of tiles on a user device. The tiles displayed on the page may include a plurality of key performance indicator (KPI) tiles and at least one of a report tile, a news tile and a collaboration tile. The method may retrieve metadata from an in-memory database, the metadata from the in-memory database may correspond to content displayed in at least one of the KPI tiles on the page. In response to an input from a user input apparatus selecting one of the tiles displayed on the page, the method may display additional details or controls for the selected tile.

Embodiments of the present disclosure addressed the above discussed shortcomings by allowing managers to configure and access their strategic and operational KPIs in a personalized cockpit. Including strategic and operational KPIs in a single cockpit allows users to make better and faster business decisions on both strategic and operational KPIs.

Utilizing an in-memory database to provide the data for the KPIs, allows for ad-hoc KPI calculations, comparisons and simulations with immediate and highly flexible visualization of the values. Managers may receive results of the organizations performance in real time, even when the input parameters are changed on the fly. Thus, the users may perform “What if” scenarios and decide the best course of action for the organization based on the results.

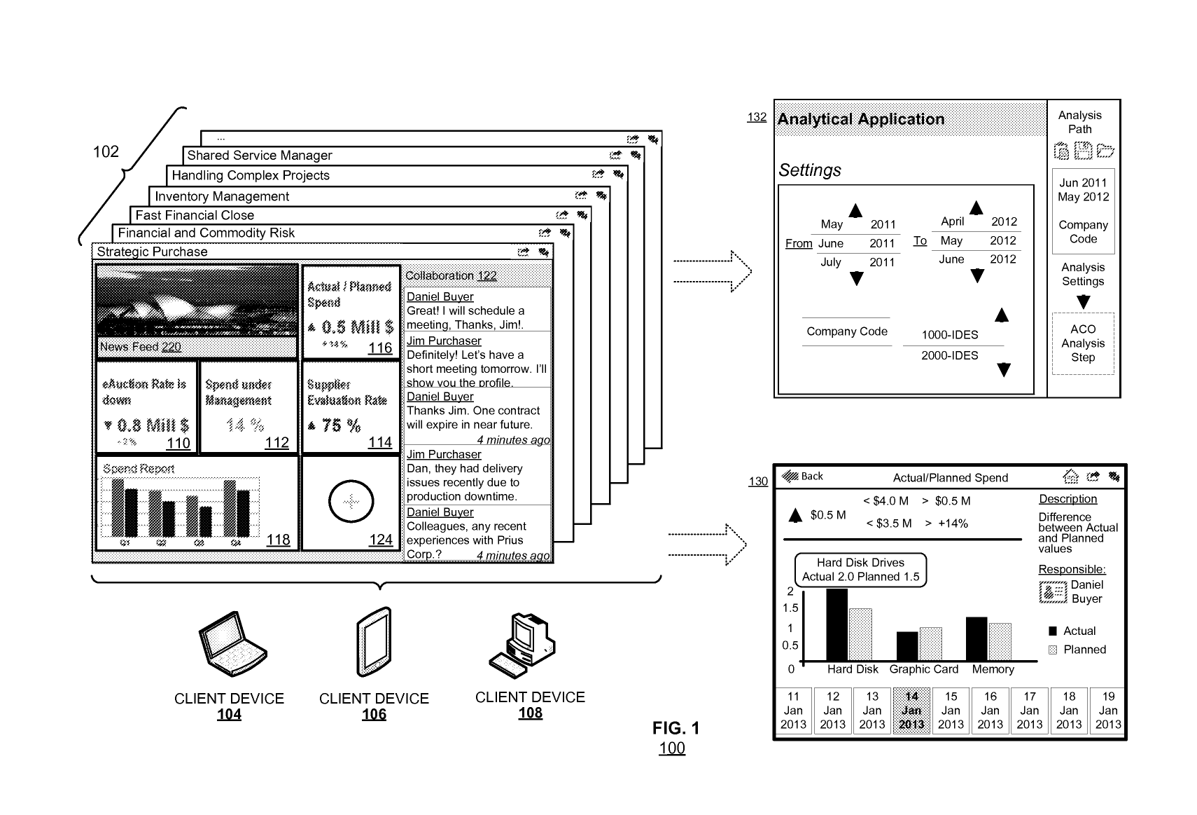

FIG. 1 illustrates an exemplary integrated platform 100 that includes a plurality of universal pages 102 according to an embodiment of the present disclosure. The universal pages 102 may be used as a home screen, where users are provided with relevant information for their tasks in one place. The universal pages 102 may provide users with a clearly structured visualization of the information using a plurality of tiles 110-122. The universal pages 102 may be displayed on a client device 104, 106 or 108 which may include, for example, a mobile device (e.g., mobile phone or a smart phone), a personal computer, a tablet, a terminal device, or a personal digital assistant (PDA). The client device 104, 106, or 108 may include an input device (e.g., a touch screen, a touch pad, a mouse or a keyboard) to receive commands from a user.

The plurality of tiles 110-120 displayed in the universal page 102 may include KPIs 110-116, reports 118, news feeds 120, collaboration threads 122 and/or custom tile 124 to add additional tiles (e.g., another KPI tile). Each page from the plurality of universal pages 102 may include its own collection of tiles 110-120 that are selected and/or arranged based on the tasks associated with the respective page. The pages 102 may be configured, for example, for: strategic purchases; financial and commodity risk; fast financial close; inventory management; handling complex projects; and shared service management. Each of the tiles 110-120 may be customized by the user.

The tiles 110-120 may provide real-time information (e.g., inventory, purchases being made, funds received, etc.) to the user of the page 102. Based on the information provided in the tiles 110-120 the user may perform specific transactional processes (e.g., material recruitments planning) or specific in depth analysis (e.g., business process management or work clearance management). Automated tasks (e.g., purchasing, transfer of funds, manufacturing adjustments, etc.) may be set by the user based on the information provided in the tiles 110-120.

The KPI tiles 110-116 may include KPIs that can be used to evaluate the performance of an organization or particular aspects of the organization's activity. The KPIs may evaluate the organization's success based on predefined goals (e.g., number of sales or customer satisfaction) or based on performance of other organizations. The KPIs may be used to evaluate the present state of an organization, predict future performance and/or identify areas for improvement. The KPIs may provide how the organization would perform if certain changes were implemented. The content of the KPI tiles 110-116 may be personalized. For example, the user may set the thresholds for the KPIs, the source of the data, method to display the content and types of notifications to be displayed. The KPIs may be calculated after respective reporting periods and intervals or may be calculated when data used to determine the KPIs is changed.

The report tile 118 may include charts and/or graphs to show visually the performance of the organization. The charts and/or graphs may include predicted performance of the organization. The report tile 118 may display information related to the one or more of the KPI tiles 110-116.

The news feed tile 120 may provide headlines and/or summarized news content that is related to the page 102 or one or more of the KPI tiles 110-116. The news feed tile 120 may include a feed with information from the organization, customers and/or partners.

The collaboration tile 122 may include a social network or a collaborative environment that bring together people, information, applications, and processes to solve business-critical problems (e.g., SAP® Jam collaboration product). The collaboration tile 122 may connect customers, partners and employees with key information to collaboration on a business task. The tiles 110-120 displayed in the page 102 or information associated with the tiles 110-120 may be provided to the collaborators via the collaboration tile 122.

Each tile 110-122 may include a context menu. The context menu may be activated by selecting the tile (e.g., right click or a double tap) or selecting a context menu icon (not shown in FIG. 1) on the tile 110-122. The context menu may include tile configuration and formatting settings, follow-on actions, additional information, options to delete the tile, and other options to modify or control the tile.

In one embodiment, by selecting (e.g., clicking or tapping on the tile) one of the tiles 110-122, users may navigate to pages that show additional details corresponding to the information of the respective tile. For example, as shown in FIG. 1, by clicking on one of the KPI tile 222 the first level tile of the page 102 may navigate to 2^{nd} level navigation target 130. The 2^{nd} level navigation target 130 may include additional details of the KPI tile 222. For example, while the KPI tile 222 may include a summary of the KPI details, the 2^{nd} level navigation target 130 may include graphs, charts, timelines, sources of information, and filtering or selections that can be made on the displayed information.

In one embodiment, clicking on one of the tiles 110-122 may display a specific application 132 (e.g., an analytical application). The specific application 132 may provide tools to perform tasks associated with the KPI tiles 110-116. The specific application 132 may include settings that can be configured to perform the analysis on the data for one or more of the KPI tiles 110-116.

The tiles 110-122 may be rearranged, resized, added and/or removed by a user to customize the display of the tiles on the display. For example, a user may tap and hold on a desired tile and then drag the tile to move the selected tile to a new location on the display page. The user may be provided with options to define the size of the page 102 (e.g., number of pixels or other units in the horizontal and vertical axis) in which the tiles 110-122 may be provided. The visualization of the tiles 110-122 may be changed based on corporate design (e.g., branding) and may include a tile for the company logos.

The type of changes that the user is allowed to make to the page 102 may be based on the role of the user. Thus, the personalization of the page 102 and/or one or more tiles 110-122 may be based on the role of the user. For example, customers of the organization may only be allowed to use the tiles 110-122 in the page 102 and may not be provided with options to change the settings or arrangement of the tiles 110-122. In contrast, the employee of the organization (e.g., administrators) may be allowed to make any type of changes to the tiles 110-122 on the page 102. The role of the user may be used as the basis to determine which tiles 110-122 are displayed, to which tiles 110-122 changes can be made and which tiles 110-122 can be added or deleted.

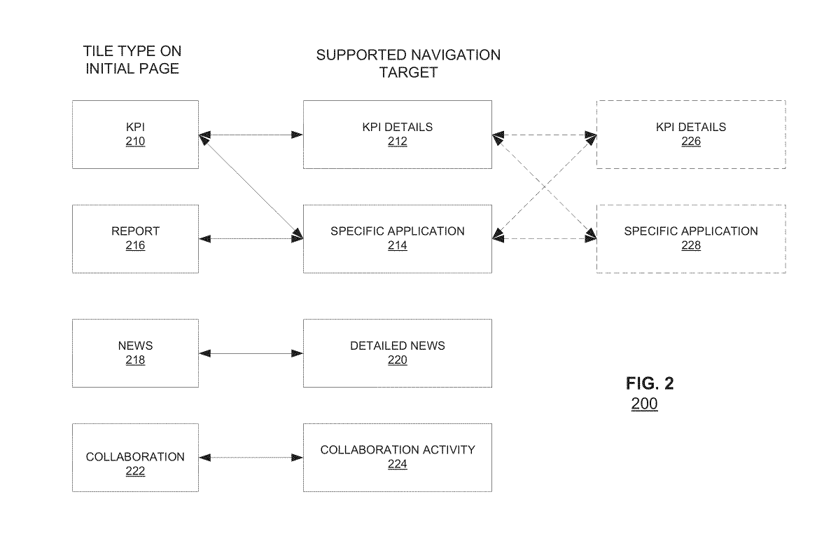

FIG. 2 illustrates possible paths for the first level navigation of the tiles 110-122 shown in FIG. 1. As show in FIG. 2, the KPI tile 210 may navigate to a navigation target that include KPI details 212 or to a specific application 214. The KPI details 212 may include graphs, diagrams, charts, tables, and/or details on how KPI details are determined. The specific application may include applications (e.g., an analytical application) to perform further analysis on the associated KPI 210. The specific application 214 may allow the user to predict performance of the KPI 210 by changing various activities of the organization.

The report KPI 216 may map to the specific application 214. The specific application 214 may allow the user to control the performance of the report 216. The specific application 214 may allow the user to predict performance of the organization that is provided in the report 216 by changing various activities of the organization.

The news tile 218 may map to a detailed news target 220. The detailed news target 220 may include detailed news content and/or settings for the news tile 218. The settings may include selecting the source of the news, the content of the news, and/or what portion of the news to display in the news tile 218.

The collaboration tile 222 may map to a collaboration activity target 224. The collaboration activity target 224 may provide the social network or the collaborative environment on a single page.

As shown in FIG. 2, a user may navigate from the supported navigation targets 212, 214, 220 and 224 back to the initial page including the tiles 210, 216, 218 and/or 222. When the user navigates to the supported navigation targets 212, 214, 220 and 224, the supported navigation targets 212, 214, 220 and 224 may be displayed by itself on a single page.

The navigation paths may include additional levels. For example, as shown in FIG. 2, the KPI details 212 may include paths to navigate to other KPI details 226 and/or specific applications 228.

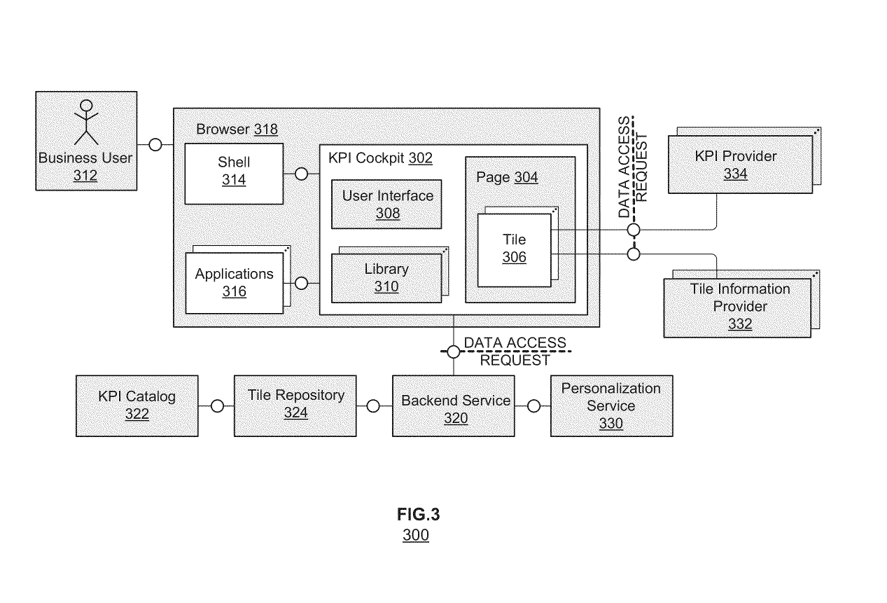

FIG. 3 illustrates basic building blocks of the KPI cockpit architecture 300 according to an embodiment of the present disclosure. The building blocks of the KPI cockpit architecture 300 may include components used as frontend services and as backend services which are accessed by the frontend components. The frontend services may be associated with KPI cockpit 302, shell 314 and applications 316. The back end services may be associated with backend service 320, KPI catalog 322, tile repository 324 and personalization services 330. The back end services may also be associated with tile information provider 332 and KPI provider 334.

The backend operations of the KPI cockpit 302 may be performed on an in-memory database (e.g., SAP® HANA database). The in-memory database may be a database management system that relies on main memory (e.g., a store which acts as a cache) for storing the data of the database. Utilizing the main memory may allow for faster retrieval of the data stored in the main memory and allow for reporting to be provided in real-time. The in-memory database may utilize multi-core processors and solid-state drives. The database may support both relational data (e.g., with row-oriented and column-oriented representations) and graphs and text processing within the same system.

The in-memory database may provide the KPI details in response to a request (e.g., via OData). The in-memory database may include the KPI repository, KPI definition tools, and perform KPI runtime and evaluation based on local data. In another embodiment, the backend services may be performed on a web application server (e.g., ABAP server running APAP (Advanced Business Application Programming) applications) and on an in-memory database. The web application server may also provide one or more of the frontend services (e.g., a user interface with the KPI cockpit 302). The KPI cockpit 302 may be provided to a client device via a browser. In another embodiment, the backend services and one or more of the frontend services may be performed on an in-memory database.

Integrating the in-memory database with the KPI cockpit 302 provides for real time analysis of variances and deviations on high volume data. The architecture may allow the user of the organization to select predictions based on current as well as on historical data. The architectures may also provide the user with immediate insight into existing deviations and make predictions on potential issues. The KPI cockpit 302 may provide the user with a combined holistic view on the status and progress of an organization's operations with respect to financial and/or logistical data. The data displayed in the KPI cockpit 302 may be driven by alerts and exceptions covering values, dates and quantities defined by the organization.

The KPI cockpit 302 may include a page 304 for displaying a plurality of tiles 306. Page 304 may be provided on a display of a client device via a browser 318. The KPI cockpit 302 may be based on a document language (e.g., markup language) for structuring and presenting content to the user 312. The KPI cockpit 302 may be based on a document language for displaying content over the Internet, a local network, or a private network. The document language may include HyperText Markup Language (HTML) (e.g., HTML5), but is not so limited.

As discussed above, the tiles 306 may include different types of tiles (e.g., tiles including KPIs, reports, news and collaboration). The type of the tiles 306 may be defined via configuration of the tile. Each tile 306 in the KPI cockpit 302 may be defined by meta-data. For each type of tiles 306 (e.g., point value type, line chart type, bar chart type, etc.), specific code may be used to produce the visualization of the content based on the meta-data. The specific code for each type of tiles 306 may include the personalization features that apply to the respective tile type

The KPI cockpit 302 may provide the user with personalization features (e.g., adding or removing tiles). The personalization features may be provided for each tile and may include changing a threshold of the content displayed in the tile. The personalization features may affect which tiles 306 are displayed, how they are displayed on the page 304 and how the content is displayed in the tile. By defining the content of the tiles 306 via the configuration instead of using code, the distributer of the KPI cockpit and the customer (e.g., users 312) may define several KPI cockpits and/or the tiles 306 based on the same application code.

The KPI cockpit 302 may include a user interface 308 and other libraries 310 to render the page 304 and/or the tiles 306. The user interface 308 may include SAP® UI5 (User Interface for HTML5). The tiles 306 that are rendered on the page 304 may be loaded using only the libraries that are provided as part of the KPI cockpit 302. The KPI cockpit 302 which renders the page 304 to show the tiles 306 may operate as a frontend component (e.g., interface between the user and a backend).

The shell 314 may provide the user 312 with navigation capabilities and/or infrastructure functionality. The navigation capabilities provided by the shell 314 may go beyond the KPI cockpit 302. The shell 314 may provide frontend services that are not bound to a specific application.

The applications 316 may include applications that are associated with one or more tiles 306. Applications 316 may include HTML (e.g., HTML5 applications). The applications 316 may be applications that are running outside of the KPI cockpit 302. The user 312 may navigate to the applications 316 by making corresponding selections on the tiles 306. Parameters describing the context of the navigation from the tile 306 within the KPI cockpit 302 to the application 316 may be passed from the tile 306 to the called application 316. Navigation by the user from the tiles 306 to detailed views of the KPIs may be handled by the KPI cockpit 302 and the specific code for the type of tile or KPI.

As discussed above, the KPI cockpit 302 may render the page 304 and/or the tiles 306. The information (e.g., descriptions of tiles and KPIs) that is needed to render the page and/or the tiles 306 may be retrieved from the backend service 320 (e.g., KPI cockpit backend service). The information may be received via a data access request using a known protocol (e.g., HTTP or Open Data Protocol (OData)). In one embodiment, the request may be made with OData via HTTP. A single HTTP request may be used to provide all of the needed meta-data to the KP cockpit 302. To achieve this in a single HTTP request, the backend service 320 may call other backend services for getting additional information for processing the request. The additional information may include, for example, details about the tiles, KPIs and other applications.

The backend service 320 may expose the list of tiles 306 to be displayed on the page 304 and meta-data describing the tiles 306. The meta-data may correspond to personalized list of tiles 306. The meta-data for KPI tiles may be stored in the KPI catalog 322. The meta-data for the tiles 306 may be stored in the tile repository 324. The meta-data for the personalization of the tiles 306 may be stored in the personalization service 330.

The KPI catalog 322 may include all of the meta-data for describing the KPIs. The KPIs may be defined by a given set of attributes (e.g., numerical values, multilingual text, technical keys, uniform resource identifiers, etc.). The same meta-data for describing the KPIs may be used for different user interfaces. Thus, the meta-data may not be user interface specific. The KPI catalog 322 may centrally maintain all of the KPIs in one place. The KPI catalog 322 allows for all of the KPIs to be defined in the same way and in one location. That is, the KPI catalog 322 may maintain the standard KPIs provided by the organization and also maintain customized or client developed KPIs. The values for the KPI may be retrieved from virtual data models (VDMs), from third party systems or from a business information warehouse.

The tile repository 324 may include a complete list of tiles that are available to be displayed in the page 304. The tile descriptions in the tile repository 324 may be user interface specific. For example, the tile descriptions may include descriptions of a tile for HTML applications and for native mobile applications. The tile descriptions may include indirections (e.g., abstract identifiers referencing concrete realizations for different user interface technologies).

The KPI cockpit 302 may receive tile information from a tile information provider 332 and KPI information from a KPI provider 334. This information may be provided in addition to the information provided via the backend service 320 from the KPI catalog 322, tile repository 324 and/or personalization service 320. The additional tile and/or KPI information may be received from third party systems or from a business information warehouse. The tile information provider 332 and/or the KPI provider 334 may provide customer-specific information to define the tiles and/or KPIs. The customer specific data may be stored in the backend service components (e.g., KPI catalog 322, tile repository 324 and/or personalization service 320).

The data for the KPI may be associated with specific customers and/or organizations. The organization and/or customers may define and maintain the KPIs. In one embodiment, defaults or sample definitions of the KPIs may be provided by the organization, distributer of the service or maintainer of the system. The system shown in FIG. 3 allows for the KPIs and the tile information to be maintained centrally in one place and using the same system. The system allows for user to utilize the same definitions (e.g., descriptive data) of the KPIs that may be stored in the same place (e.g., KPI catalog 322).

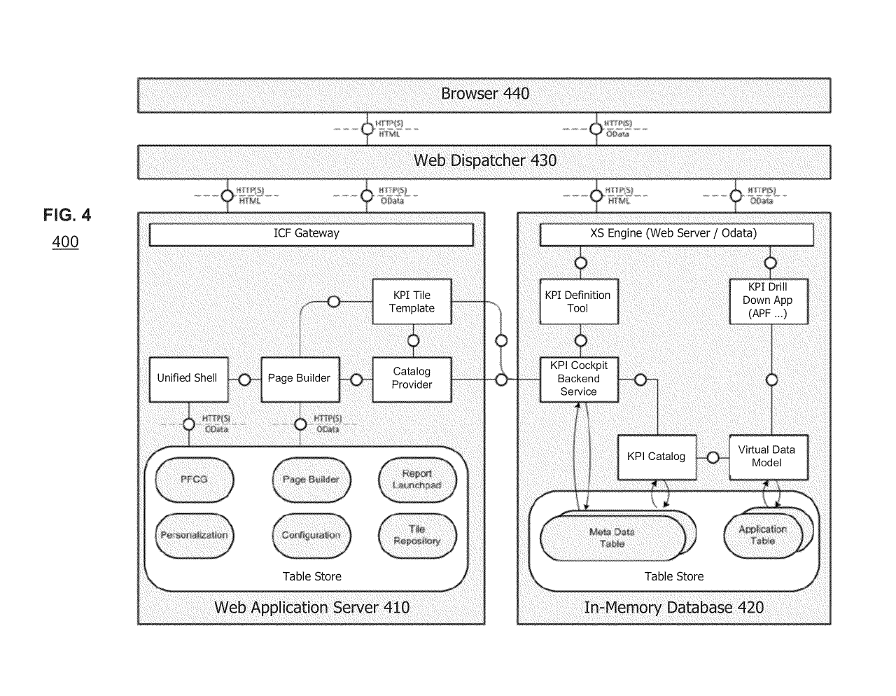

FIG. 4 illustrates system 400 integrating of a web application server 410 and an in-memory database 420 to provide KPI cockpit according to an embodiment of the present disclosure. The web application server 410 may be an Advanced Business Application Programming Server and the in-memory database 420 a SAP® HANA database, but are not so limited. FIG. 4 illustrates how the components shown in FIG. 3 may be distributed between the web application server 410 and the in-memory database 420. The system 400 may operate such that the frontend and the backend components are not limited by the type of frontend and/or the back end components used in the system 400. Thus, the same frontend components (e.g., communication libraries, navigation shells) may be reused specific types of backend stacks used in the system (e.g., ABAP server and/or HANA). OData (Open Data Protocol) may be used by the system 400 to communicate between the frontend and the backend components.

The web application server 410 and the in-memory database 420 may perform the backend operations. The web application server 410 may perform one or more of the fronted operations. The web application server 410 may provide a user interface with the KPI cockpit to a browser 440. The KPI cockpit may be provided to the browser 440 via a web dispatcher 430. The web dispatcher 430 may be provided to process the HTML and OData protocol content from the web application server 410 and an in-memory database 420, respectively.

User interface artifacts corresponding to the KPI tiles to be displayed in the KPI cockpit may be stored in the stack of the web application server 410. Reporting of the information for the KPI tiles may be performed via the PCFG (role maintenance) and Report Launchpad. The PFCG may perform role maintenance administration to manage roles and authorization of data on the ABAP stack which includes the user interface artifacts corresponding to the KPI tiles.

Drill down applications and 2^{nd} level applications used to analyze the KPIs further, may be provided on the in-memory database 430 stack. The in-memory database 430 stack may also include the KPI framework definition, runtime aspects (e.g., without visualization) and all of the drill down applications.

The integration of KPIs into the tile catalog of the unified shell may be performed via a catalog provider in the web application server 410. The catalog provider may access the KPI catalog of the in-memory database 430 and provide a list of KPIs to the end user. The catalog provider may need to authenticate the current user's credentials against the in-memory database 430 to make use of the authorization concept in in-memory database 430. Thus, the organization may restrict the list of KPIs per user and/or the role of the user in the organization.

Once a user selects a KPI, the catalog provider in the web application server 410 may create a configuration containing resource locators (e.g., URLs) to the corresponding in-memory database 430 services (e.g., query, annotation, etc.) for the KPI tile templates. The KPI tile templates and the configuration may be passed to the page builder in the web application server 410. The page builder may render the KPI for display in the KPI cockpit.

The KPIs may be defined by meta-data. A specific set of attributes may define each of the KPIs, which may include numerical values, multilingual text, technical keys, and/or URI (uniform resource identifier). The specific attributes of the KPI may be defined by a user, an organization, provider or administrator of the system. The components of the system may search for the KPIs based on the attribute values. As discussed above, the KPIs may be defined independent of the user interface technology used to display the KPs. Providing KPIs that are independent of the user interface technology may allow for meta-data defined by the users to be reused.

The values for the KPI may be retrieved by the KPI catalog from virtual data models (VDMs) in the in-memory database 420, from third party systems or from a business information warehouse.

While some concepts of the system are described above with reference to a ABAP sever and a HANA, the concepts may be applied to other infrastructures.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the disclosure may be implemented using Java, C++, or other object-oriented programming language and development tools. Another embodiment of the disclosure may be implemented in hard-wired circuitry in place of, or in combination with machine readable software instructions.

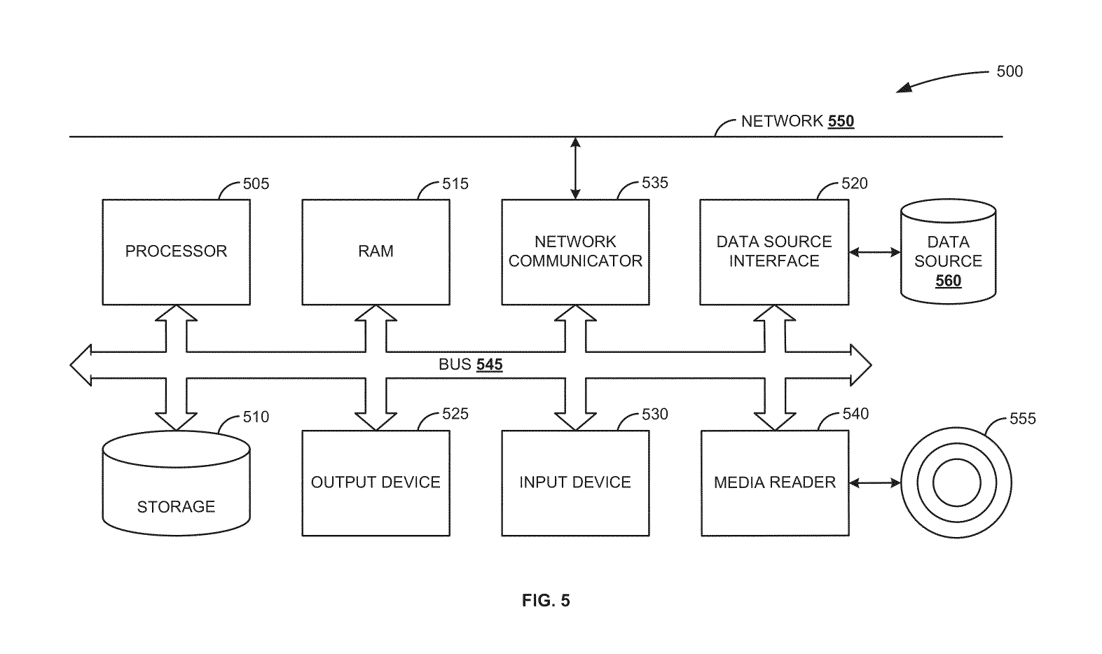

FIG. 5 is a block diagram of an exemplary computer system 500. The computer system 500 includes a processor 505 that executes software instructions or code stored on a computer readable storage medium 555 to perform the above-illustrated embodiments of the disclosure. The computer system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. The stored instructions may be further compiled to generate other representations of the instructions and dynamically stored in the RAM 515. The processor 505 reads instructions from the RAM 515 and performs actions as instructed. According to one embodiment of the disclosure, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Each of these output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 520 to access data source 560. The data source 560 can be accessed via one or more abstraction layers implemented in hardware or software. For example, the data source 560 may be accessed by network 550. In some embodiments the data source 560 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

A semantic layer is an abstraction overlying one or more data sources. It removes the need for a user to master the various subtleties of existing query languages when writing queries. The provided abstraction includes metadata description of the data sources. The metadata can include terms meaningful for a user in place of the logical or physical descriptions used by the data source. For example, common business terms in place of table and column names. These terms can be localized and or domain specific. The layer may include logic associated with the underlying data allowing it to automatically formulate queries for execution against the underlying data sources. The logic includes connection to, structure for, and aspects of the data sources. Some semantic layers can be published, so that it can be shared by many clients and users. Some semantic layers implement security at a granularity corresponding to the underlying data sources' structure or at the semantic layer. The specific forms of semantic layers includes data model objects that describe the underlying data source and define dimensions, attributes and measures with the underlying data. The objects can represent relationships between dimension members, provides calculations associated with the underlying data.

In the above description, numerous specific details are set forth to provide a thorough understanding of embodiments of the disclosure. One skilled in the relevant art will recognize, however that the various embodiments can be practiced without one or more of the specific details or with other methods, components, techniques, etc. In other instances, well-known operations or structures are not shown or described in detail to avoid obscuring aspects of the disclosure.

Although the processes illustrated and described herein include series of steps, it will be appreciated that the different embodiments of the present disclosure are not limited by the illustrated ordering of steps, as some steps may occur in different orders, some concurrently with other steps apart from that shown and described herein. In addition, not all illustrated steps may be required to implement a methodology in accordance with the present disclosure. Moreover, it will be appreciated that the processes may be implemented in association with the apparatus and systems illustrated and described herein as well as in association with other systems not illustrated.

The above descriptions and illustrations of embodiments of the disclosure, including what is described in the Abstract, is not intended to be exhaustive or to limit the embodiments to the precise forms disclosed. While specific embodiments of, and examples for, the embodiments are described herein for illustrative purposes, various equivalent modifications are possible within the scope of the disclosure, as those skilled in the relevant art will recognize. These modifications can be made to the embodiments in light of the above detailed description.

We claim:

1. A computer implemented method comprising:
displaying a page with a plurality of tiles on a user device, the tiles including a plurality of key performance indicator (KPI) tiles and at least one of a report tile, a news tile and a collaboration tile;
retrieving metadata from an in-memory database, the metadata from the in-memory database corresponding to content displayed in at least one of the KPI tiles on the page;
receiving an input at a user input apparatus indicating that the user is selecting one of the tiles displayed on the page; and
in response to selecting one of the tiles, displaying additional details or controls for the selected tile.

2. The computer implemented method of claim 1, further comprising retrieving metadata from a web application server, wherein the metadata from the web application server describes the tiles displayed on the page.

3. The computer implemented method of claim 2, wherein the description of the tiles is specific to a type of user interface displayed on the user device.

4. The computer implemented method of claim 2, wherein the metadata from a web application server includes description for all of the tiles displayed on the page.

5. The computer implemented method of claim 1, wherein the metadata from the in-memory database is not specific to a type of user interface displayed on the user device.

6. The computer implemented method of claim 1, wherein if one of the KPI tiles is selected, displaying additional details of the one or more KPIs associated with the selected KPI tile.

7. The computer implemented method of claim 1, wherein if one of the KPI tiles is selected, displaying an analytical application that is associated with the selected KPI tile.

8. The computer implemented method of claim 1, wherein the controls for the selected tile include at least one of tile configuration, tile formatting settings, follow-on action setting, option to delete the selected tile, option to relocate the selected tile, and options to change a threshold of the selected tile.

9. The computer implemented method of claim 1, wherein displaying the page with the plurality of tiles includes displaying tiles which are associated with a role of a user using the user device and hiding or deactivating tiles which are not associated with the role of the user using the user device.

10. A non-transitory computer readable medium containing program instructions for providing a user interface on a user device, wherein execution of the program instructions by one or more processors of a computer system causes one or more processors to carry out the steps of:
displaying a page with a plurality of tiles on the user device, the tiles including a plurality of key performance indicator (KPI) tiles and at least one of a report tile, a news tile and a collaboration tile;
retrieving metadata from an in-memory database, the metadata from the in-memory database corresponding to content displayed in at least one of the KPI tiles on the page;
receiving an input at a user input apparatus indicating that the user is selecting one of the tiles displayed on the page; and
in response to selecting one of the tiles, providing additional details or controls for the selected tile.

11. The non-transitory computer-readable medium according to claim 10, further including step of retrieving metadata from a web application server, wherein the metadata from the web application server describes the tiles displayed on the page.

12. The non-transitory computer-readable medium according to claim 11, wherein the description of the tiles is specific to a type of the user interface displayed on the user device.

13. The non-transitory computer-readable medium according to claim 10, wherein the metadata from the in-memory database is not specific to a type of user interface displayed on the user device.

14. The non-transitory computer-readable medium according to claim 10, wherein if one of the KPI tiles is selected, displaying an analytical application which is associated with the selected KPI tile.

15. The non-transitory computer-readable medium according to claim 10, wherein the controls for the selected tile include at least one of tile configuration, tile formatting settings, follow-on action setting, option to delete the selected tile, option to relocate the selected tile, and options to change a threshold of the selected tile.

16. A system comprising:
an in-memory database for providing key performance indicator details, the in-memory database including:
a KPI catalog providing a list of KPIs based on KPI related data stored in memory,
a virtual dada model providing values for the KPIs based on the KPI related data stored in the memory, and
a backend service retrieving the list of KPIs and the values for the KPIs in response to a request;
a web application server coupled to the in-memory database, the web application server including:
a page builder to render a page including a plurality of tiles based on metadata stored in memory of the web application server, the plurality of tiles including a plurality of KPI tiles and at least one of a report tile, a news tile and a collaboration tile,
a unified shell providing navigation capabilities of the tiles displayed in the page, and
a catalog provider integrating the list of KPIs, values for the KPIs and the tiles on the page; and
a browser for displaying the rendered page provided by the page builder.

17. The system of claim 16, wherein the rendered page is provided to the browser via a web dispatcher coupled to the web application server and the in-memory database.

18. The system of claim 16 wherein the in-memory database is a HANA database and the web application server is an Advanced Business Application Programming Server.

19. The system of claim 16, wherein the KPI related data stored in the memory of the in-memory database is not specific to a type of user interface displayed in the browser and the tile related data stored in the memory of the web application server is specific to the type of user interface displayed in the browser.

20. A computer implemented method comprising:
displaying a page with a plurality of tiles on a user device, the tiles including a plurality of key performance indicator (KPI) tiles, a report tile, a news tile and a collaboration tile;
retrieving metadata from an in-memory database, wherein the metadata from the in-memory database corresponding to content displayed in at least one of the KPI tiles on the page and the metadata from the in-memory database is not specific to a type of user interface displayed on the user device;
retrieving metadata from a web application server, wherein the metadata from the web application server describes the tiles displayed on the page and the description of the tiles is specific to the type of user interface displayed on the user device;
receiving an input at a user input apparatus indicating that the user is selecting one of the tiles displayed on the page;
in response to selecting one of the tiles, displaying additional details on the content displayed in the selected tile;
receiving an input at the user input apparatus indicating that the user is selecting a settings control for a specific tile;
in response to selecting the settings control for the specific tile, displaying a context menu including tile configuration and formatting settings for the specific tile.
